(19) United States
(12) Patent Application Publication
(10) Pub. No.: US 2007/0009305 A1
(43) Pub. Date: Jan. 11, 2007

(54) Printer

(75) Inventors: Tsuyoshi Sakaino, Tokyo (JP); Sumio Miura, Isehara-shi (JP)

Correspondence Address: SMITH, GAMBRELL & RUSSELL, 1850 M STREET, N.W., SUITE 800, WASHINGTON, DC, 20036, US

(73) Assignee: Citizen Watch Co., Ltd.

(21) Appl. No.: 11/364,187

(22) Filed: Mar. 1, 2006

(30) Foreign Application Priority Data
Jun. 30, 2005 (JP) 193204/2005

(51) Int. Cl. B41J 15/00

(52) U.S. Cl. 400/613

(57) ABSTRACT

In a printer for printing a rolled printing paper, a front panel is attached to a frame that houses a print unit and a paper holder unit. When the front panel is opened, the print unit and the paper holder unit project on the front side of the frame in association with the action of the front panel.

### BACKGROUND OF THE INVENTION

1. Field of the Invention

The present invention relates to a printer in which printing paper can be loaded and replaced with ease.

2. Description of the Related Art

Some known printers are incorporated in various in- and outdoor vending machines and the like and used to issue recorded papers, receipts, tickets, etc. One such printer is described in Japanese Patent Application Laid-Open No. 2002-154719. This conventional printer will now be described with reference to FIGS. 15 and 16.

In replacing a printing paper 150 with a new one, the upper end portion of a unit mounting section 144b that forms a front surface of a body bracket 144 shown in FIG. 15 is pulled in the direction indicated by arrow P (counterclockwise direction). Thereupon, the body bracket 144 is swung around a pivot shaft 148 and moved to the position of FIG. 16. When the body bracket 144 is in the state of FIG. 16, holding members 151 for a rolled paper 150 mounted on a rolled paper mounting section 144a that constitutes the bottom of the body bracket 144 is situated on the upper front side, while an insertion slot 152 for the rolled paper 150 is situated on the lower front side.

In this state, the used rolled paper 150 is disengaged from the holding members 151, and a new rolled paper 150 is mounted on the holding members 151. The leading end portion of the paper 150 is drawn out and inserted into the insertion slot 152 of the unit mounting section 144b. Then, it passes through a print control unit 145 and discharged to the outside through its outlet 153.

Thereafter, the body bracket 144 is swung in the direction indicated by arrow Q (clockwise direction) and restored to its original position (FIG. 15). Subsequently, a feed mechanism is operated to cause the leading end portion of the rolled paper 150 to project a suitable length from the outlet 153, whereupon printing is enabled.

Replacing the rolled paper 150 is very hard when the body bracket 144 of the printer is in the state of FIG. 15. If the bracket 144 is swung counterclockwise around the pivot shaft 148, as shown in FIG. 16, however, the holding members 151 are situated on the upper front side, and the insertion slot 152 for the rolled paper 150 is situated on the lower front side, so that the replacement of the paper 150 is easy.

Since the print control unit 145 is attached to the front of the unit mounting section 144b, it is susceptible to external adverse effects, such as external damage, exposure to dust, etc. Further, no receiving members underlie the holding members 151. If the rolled paper 150 fails to be properly mounted on the holding members 151, therefore, it naturally falls and cannot be easily mounted again. In causing the rolled paper 150 to pass through the print control unit 145, furthermore, the leading end portion of the paper 150 is inserted into the insertion slot 152 in the unit mounting section 144b. Inevitably, therefore, the rolled paper cannot be set in the print control unit 145 with ease.

### SUMMARY OF THE INVENTION

The present invention relates a printer for printing a rolled printing paper.

A printer according to a first aspect of the present invention comprises a frame; a front panel swingably attached to and supported on the frame; a print unit for printing the rolled printing paper, housed in the frame and configured to move toward the front of the frame as the front panel is opened; and a paper holder unit for holding the rolled printing paper, housed in the frame and configured to move toward the front of the frame as the front panel is opened.

The print unit may be attached to a rear surface of the front panel, and the paper holder unit is mounted for longitudinal movement in the frame and coupled to the front panel by a link.

A paper cutting unit for cutting the printed paper may be attached to the rear surface of the front panel.

The paper holder unit may be formed of a bottom plate and side plates and configured to be loaded with the printing paper from above. Further, the frame may have a top opening through which the printing paper is inserted from above and loaded into the paper holder unit. Furthermore, the front panel may be provided with a paper exit through which the printed paper is discharged, and a paper end portion of the printing paper is delivered to the paper exit through the paper cutting unit as the paper end portion is inserted into the print unit from above with the front panel open.

The printing paper may be loaded into the paper holder unit when the front panel is fully opened. The side plates of the paper holder unit may be formed individually having paper supporting shaft locking claws, and the paper supporting shafts are configured to be attached and detached by deforming the locking claws.

The paper holder unit may configured to be mounted with a plurality of paper supporting shafts having different diameters.

A printer according to a second aspect of the present invention comprises: a frame having a top opening; a front panel swingably attached to a front surface of the frame and having a paper exit through which the printed paper is discharged; a print unit attached to the front panel and configured to print the printing paper; a paper cutting unit attached to the front panel and configured to cut the printed paper; a paper holder unit for holding the printing paper, mounted for longitudinal movement in the frame and coupled to the front panel by a link; and a control circuit unit for controlling the print unit and the paper cutting unit; wherein the control circuit unit has an adjusting element configured to be operated through the top opening of the frame when the front panel is opened halfway.

The adjusting element may be a DIP switch.

A base plate is fixedly attached to the frame, a slide plate is mounted on the base plate for longitudinal movement with respect to the base plate, and further the paper holder unit is mounted on this slide plate for longitudinal movement with respect to the slide plate; a base plate opening is formed in the base plate so as to face the adjusting element; a slide plate opening is formed in the slide plate so that the slide plate opening faces the base plate opening of the base plate when the slide plate moves to reach a predetermined position; and the base plate opening, slide plate opening, and paper holder bottom opening are moved to a position where these openings are aligned one another, thereby allowing the adjusting element to be operated when the front panel is opened halfway.

According to the present invention arranged in this manner, there may be provided a printer in which the printing paper can be loaded and replaced with ease and the control circuit unit can be protected against external adverse effects, such as external damage, exposure to dust, etc.

### BRIEF DESCRIPTION OF THE DRAWINGS

The above and other objects and features of the present invention will be apparent from the ensuing description of embodiments with reference to the accompanying drawings, in which:

FIG. 1 is a perspective view showing an appearance of a printer according to an embodiment of the invention;

FIG. 2 is a sectional view of the printer taken along line A-A of FIG. 1;

FIG. 3 is a view illustrating the printer of FIG. 2 with its front panel open;

FIG. 4 is a view illustrating the way a printing paper is loaded into a paper holder unit of the printer of FIG. 3;

FIG. 5 is a view illustrating the printer of FIG. 4 with its front panel closed;

FIG. 6 is a view illustrating the way the printing paper is loaded into the paper holder unit of the printer of FIG. 2;

FIG. 7 is a view showing a state in which the printing paper set in the paper holder unit of the printer is further transported from the state of FIG. 6 so that its end portion projects from a paper exit;

FIG. 8 is a view showing a state in which a DIP switch is operated with a tool passed through respective openings of a base plate, slide plate, and bottom plate of the paper holder unit with the front panel opened halfway;

FIG. 9 is a view showing a state in which a first paper supporting shaft is mounted on a side plate of the paper holder unit of the printer of FIG. 2;

FIG. 10 is an enlarged detailed view showing a state in which the first paper supporting shaft indicated by symbol B in FIG. 9 is mounted on the paper holder side plate;

FIG. 11 is a rear view showing a state in which the first paper supporting shaft shown in FIG. 10 is mounted on the paper holder side plate;

FIG. 12A is a view illustrating the way the first paper supporting shaft shown in FIG. 11 is removed from the paper holder side plate;

FIG. 12B is a sectional view taken along line C-C of FIG. 12A;

FIG. 13A is a view illustrating the way the first paper supporting shaft of FIG. 12A is removed from the paper holder side plate and a second paper supporting shaft is mounted;

FIG. 13B is a sectional view taken along line D-D of FIG. 13A;

FIG. 14 is a detailed view showing a state in which the second paper supporting shaft is mounted, in place of the first paper supporting shaft of FIG. 12, on the paper holder side plate;

FIG. 15 is a perspective view showing a stable state of a conventional printer; and

FIG. 16 is a perspective view showing a state in which a printing paper for the printer shown in FIG. 15 is replaced with a new one.

### DETAILED DESCRIPTION OF THE PREFERRED EMBODIMENTS

A printer according to the present invention prints and discharges a rolled printing paper. It comprises a frame, front panel, print unit, paper cutting unit, and paper holder unit. The frame partially covers the bottom, side, rear, and top surfaces of the printer. The front panel is swingably attached to the front face of the frame and has a paper exit through which the printed paper is discharged. The print unit is attached to the rear surface of the front panel and serves to print the printing paper. The paper cutting unit is attached to the rear surface of the front panel and serves to cut the printed paper. The paper holder unit is mounted for longitudinal movement in the frame and coupled to the front panel by a link, serving to hold the printing paper. If the front panel is opened, the print unit, paper cutting unit, and paper holder unit get out of the frame through its front surface.

The paper holder unit is formed of a bottom plate and side plates such that the printing paper can be loaded from above. The frame is provided with a top opening through which the printing paper is loaded into the paper holder unit. Thus, the printing paper can be loaded into the paper holder unit from above the frame. If the front panel is fully opened, moreover, the printing paper can be loaded into the paper holder unit through the front of the printer.

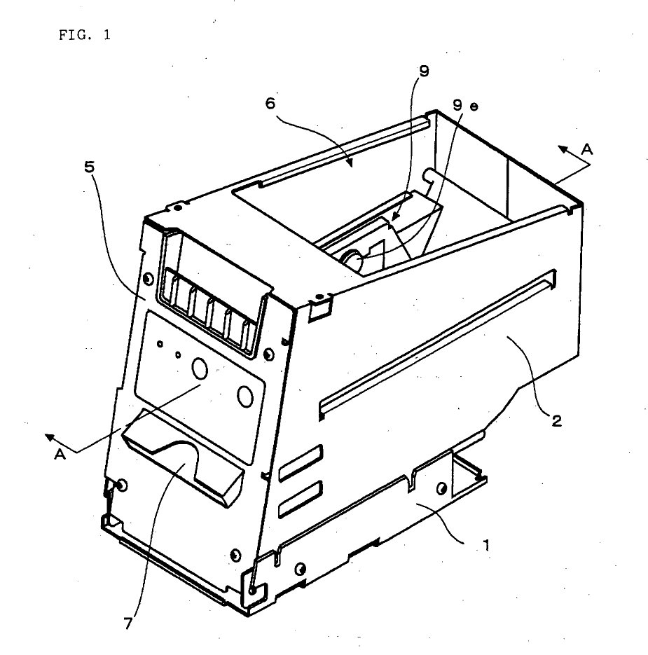

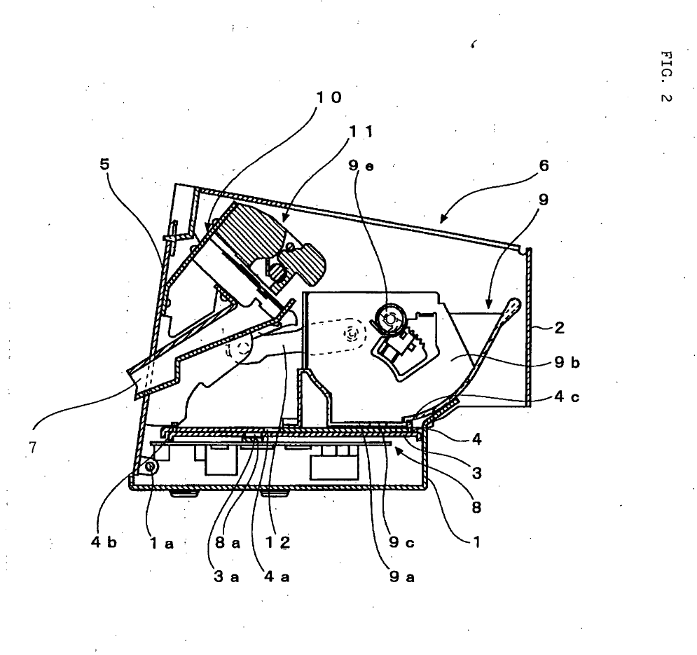

The configuration of a printer according to an embodiment of the present invention will now be described with reference to FIGS. 1 and 2.

A lower frame 1 and an upper frame 2 form a printer case that encloses the whole surfaces of the printer except parts of the front and top surfaces. A control circuit unit 8 is mounted in the lower frame 1. The control circuit unit 8 is provided with a DIP switch 8a as an externally accessible adjusting element for changing the operation mode. On the other hand, a paper holder unit 9 is incorporated in the upper frame 2. The front surface of the upper frame 2 is closed by a front panel 5 that is swingably mounted on pivots 1a.

A print unit 10 and a paper cutting unit 11 are mounted on the inner surface of the front panel 5. The print unit 10 is mounted so that its side on which an unused printing paper 13 (mentioned later) is inserted faces obliquely upward and that its side on which the printed paper 13 is discharged faces obliquely downward. The paper cutting unit 11 is mounted so that its side on which the printed paper 13 is inserted is located near the side of the print unit 10 on which the paper 13 is discharged and that its side on which the paper 13 is discharged faces obliquely downward. Further, a paper exit 7 is provided so that its paper insertion side is located near the side of the paper cutting unit 11 on which the paper is discharged. Thus, the printing paper 13 having passed through the print unit 10 and the paper cutting unit 11 is discharged to the outside of the front panel 5.

A base plate 3 is mounted between the lower and upper frames 1 and 2. A base plate opening 3a is formed in that part of the base plate 3 which faces the DIP switch 8a. On the other hand, a slide plate 4 is mounted on the top surface of the base plate 3 so as to be longitudinally movable with respect to the base plate 3.

A slide plate opening 4a is formed in the slide plate 4. It is situated in a position such that it faces the DIP switch 8a when the slide plate 4 is moved to a specific position. Further, first and second slide plate engaging pins 4b and 4c are fixed to the front and rear ends, respectively, of the slide plate 4. A paper holder unit 9 is mounted on the top surface of the slide plate 4 so as to be longitudinally movable with respect to the slide plate 4.

The paper holder unit 9 is in the form of a cup that is defined by a paper holder bottom plate 9a, which forms bottom, front, and rear walls, and paper holder side plates 9b, which form opposite side walls. First paper supporting shafts 9e are mounted on the side plates 9b, individually. A paper holder bottom opening 9c is formed in the bottom plate 9a. It is situated in a position such that it faces the DIP switch 8a when the paper holder unit 9 is moved on the slide plate 4 to a specific position.

The paper holder unit 9 and the front panel 5 are coupled to each other by a link 12. If the front panel 5 is opened, the holder unit 9 moves forward. If the former is closed, the latter moves backward.

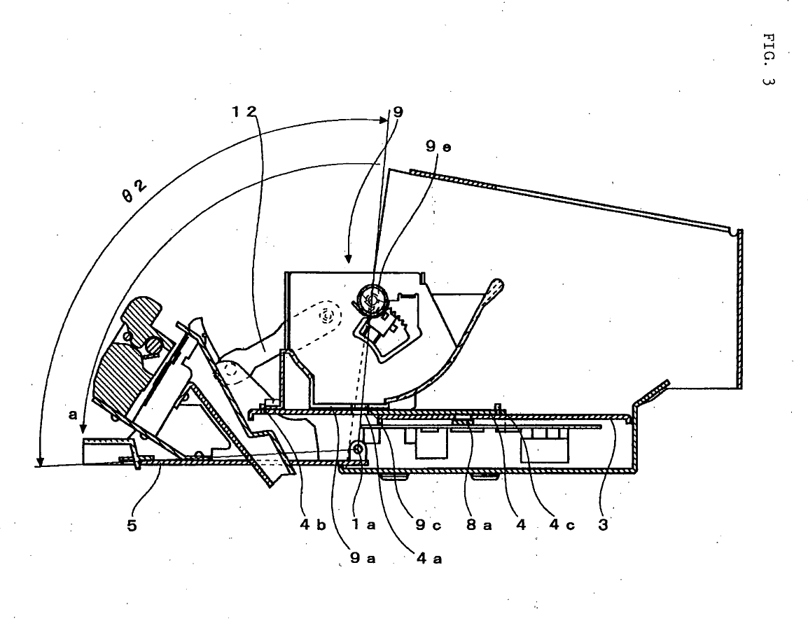

Operation for opening the front panel 5 of the printer shown in FIG. 2 will now be described with reference to FIG. 3.

In loading the printing paper 13 into the paper holder unit 9, the front panel 5 is swung open around the pivots 1a with its upper end portion held by hand. When the front panel 5 is opened at an angle θ2 shown in FIG. 3, the paper holder unit 9 that is coupled to the front panel 5 by the link 12 moves forward to the position shown in FIG. 3.

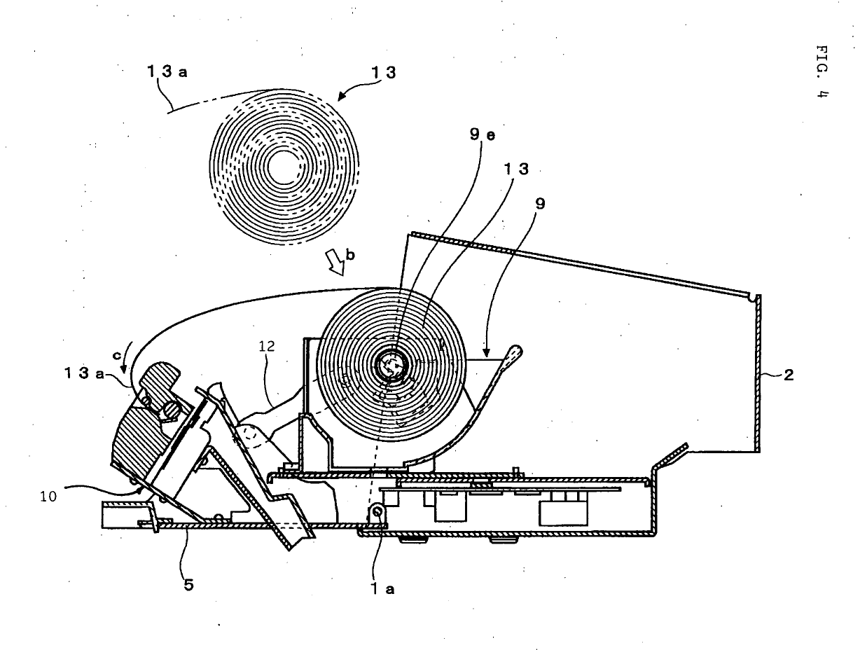

A first operation for loading the printing paper 13 into the paper holder unit 9 of the printer shown in FIG. 3 will now be described with reference to FIG. 4.

If the front panel 5 is fully opened, a part of the paper holder unit 9 is caused to project forward from the upper frame 2 by the action of the link 12. Thereupon, the printing paper 13 can be put into the holder unit 9 as indicated by arrow b and set on the first paper supporting shafts 9e.

If the front panel 5 is fully opened, moreover, the print unit 10 moves further forward, so that a paper end portion 13a of the printing paper 13 on the first paper supporting shafts 9e can be easily inserted into the print unit 10, as indicated by arrow c.

Operation for closing the front panel 5 of the printer shown in FIG. 4 will now be described with reference to FIG. 5.

If the front panel 5 is swung in the direction indicated by arrow d with its upper end portion held by hand, the paper holder unit 9 that is coupled to the front panel 5 by the link 12 moves backward to the position shown in FIG. 5.

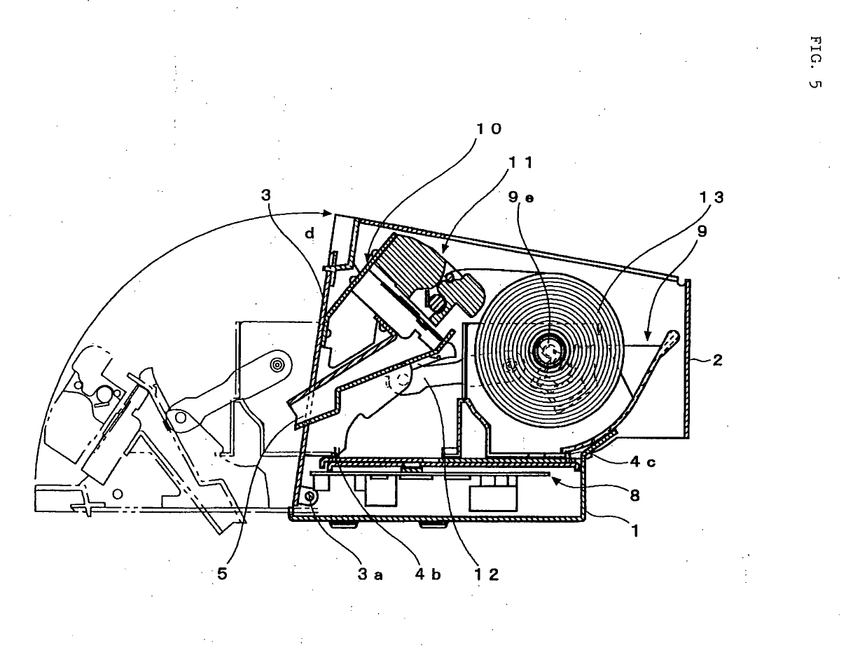

A second operation for loading the printing paper 13 into the paper holder unit 9 of the printer shown in FIG. 2 will now be described with reference to FIG. 6.

With the front panel 5 kept closed, the printing paper 13 is put into the paper holder unit 9 as indicated by arrow e through a top opening 6 in the upper frame 2 and set on the first paper supporting shafts 9e. Then, the end portion 13a of the paper 13 on the shafts 9e is inserted into the print unit 10, as indicated by arrow f.

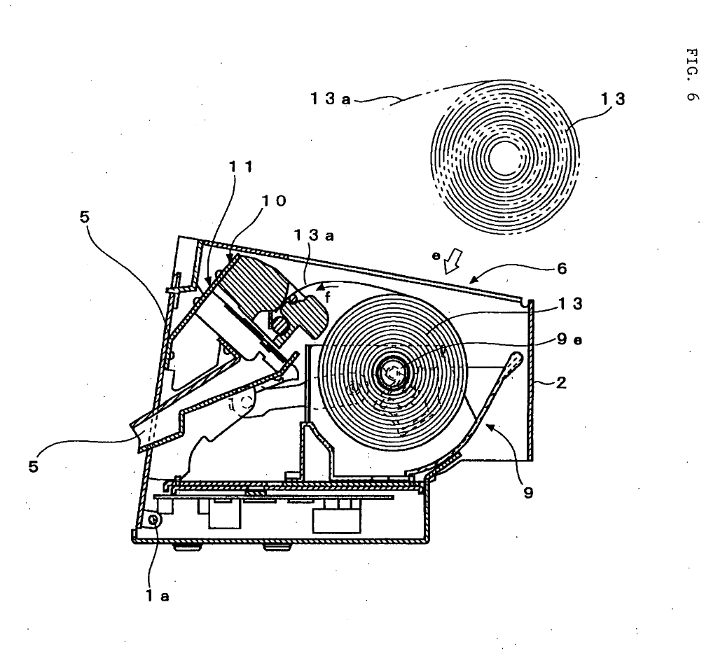

Operation for taking out the paper end portion 13a of the printing paper 13 in the printer shown in FIGS. 5 and 6 through the paper exit 7 will now be described with reference to FIG. 7.

If the paper end portion 13a of the printing paper 13 loaded on the first paper supporting shafts 9e is inserted into the print unit 10 in the manner shown in FIG. 5 or 6, a sensor (not shown) attached to the print unit 10 detects the end portion 13a and sends a signal to the control circuit unit 8. Thereupon, the control circuit unit 8 drives paper feeding means (not shown) to feed the printing paper 13 in response to this signal, thereby moving the paper 13 to a position in which the paper end portion 13a slightly projects from the paper exit 7.

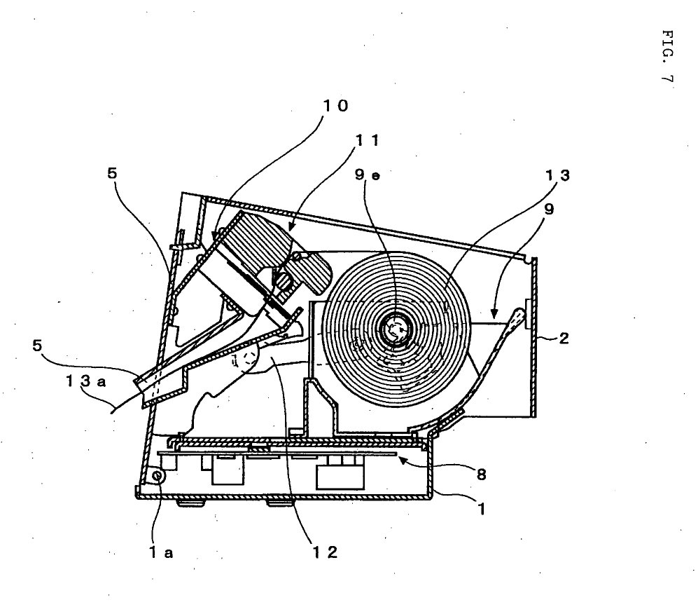

A state in which the DIP-switch 8a on the control circuit unit 8 is operated will now be described with reference to FIG. 8.

When the front panel 5 is opened at an angle θ1 in the direction indicated by arrow g from the state of FIG. 2, the paper holder unit 9 that is coupled to the front panel 5 by the link 12 moves forward. Since the front end portion of the holder unit 9 is in engagement with the first slide plate engaging pin 4b, the slide plate 4 also moves forward as the holder unit 9 moves forward.

As the slide plate 4 moves forward, the slide plate opening 4a in the slide plate 4 and the paper holder bottom opening 9c in the bottom plate 9a of the paper holder unit 9 are aligned with each other in a position where they face the DIP switch 8a. Thus, in the position opposite the DIP switch 8a, the base plate opening 3a, slide plate opening 4a, and paper holder bottom opening 9c face one another. Therefore, the DIP switch 8a can be operated through the openings 3a, 4a and 9c by using a first tool 14, for example.

Thus, when the paper holder unit 9 is in a steady-state position shown in FIG. 2 with the front panel 5 closed and when it is in the state of FIG. 3 where it projects forward with the front panel 5 open, the slide plate opening 4a or the paper holder bottom plate 9a covers the base plate opening 3a that faces the DIP switch 8a, so that the switch 8a cannot be externally affected by any foreign matter.

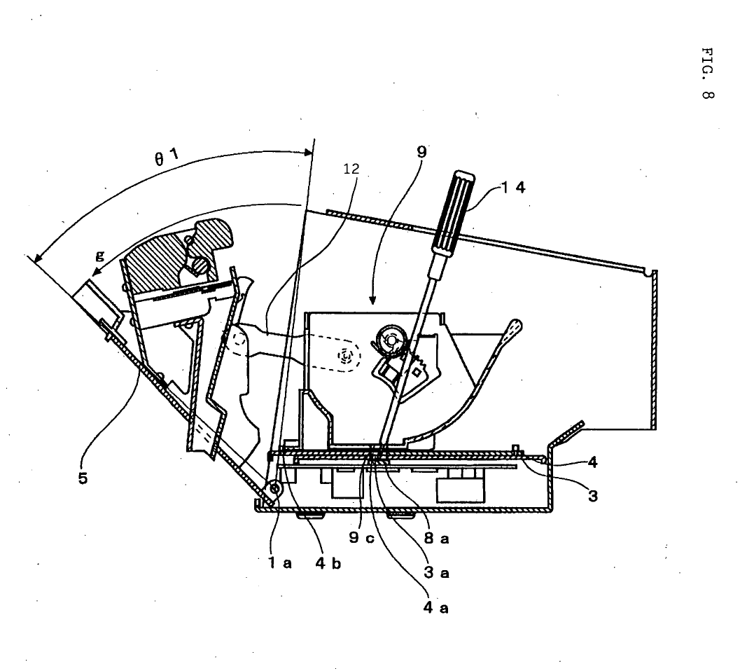

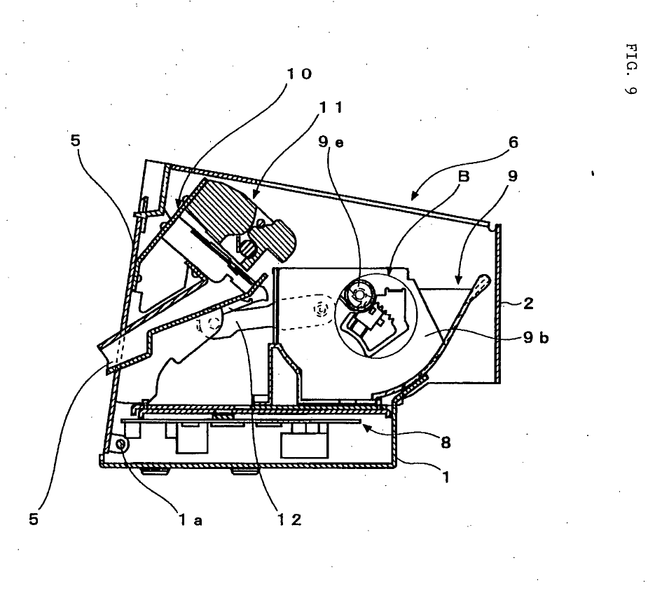

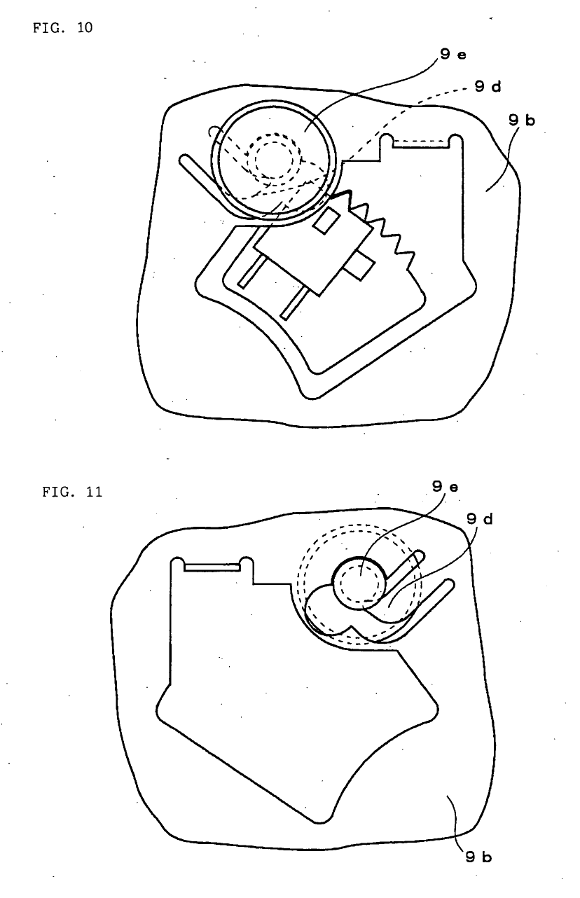

A state in which each first paper supporting shaft 9e is mounted on each side plate 9b of the paper holder unit 9 will now be described with reference to FIG. 9 and its enlarged views of FIGS. 10 and 11.

As shown in FIG. 11, each first paper supporting shaft 9e is retained by a paper supporting shaft locking claw 9d that is formed by cutting a part of each paper holder side plate 9b.

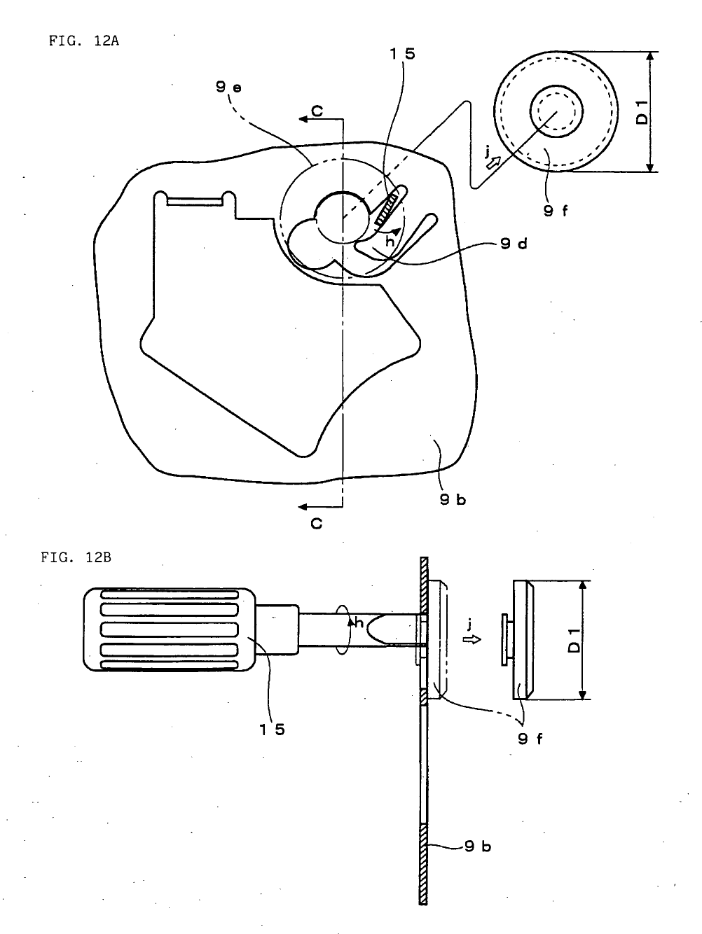

The way each first paper supporting shaft 9e provided on each paper holder side plate 9b is removed will now be described with reference to FIGS. 12A and 12B.

If the inside diameter of a bobbin for the printing paper 13 to be set is D1, the first paper supporting shafts 9e are used in the aforesaid manner. If the inside diameter of the bobbin is not D1, however, the supporting shafts 9e are removed and replaced with any other supporting shafts that match the bobbin diameter for the printing paper 13.

In removing each first paper supporting shaft 9e, the paper supporting shaft locking claw 9d is deformed in the direction indicated by arrow h in FIG. 12A by means of a second tool 15, for example, and the supporting shaft 9e is disengaged from the paper holder side plate 9b in the direction indicated by arrow j (axial direction).

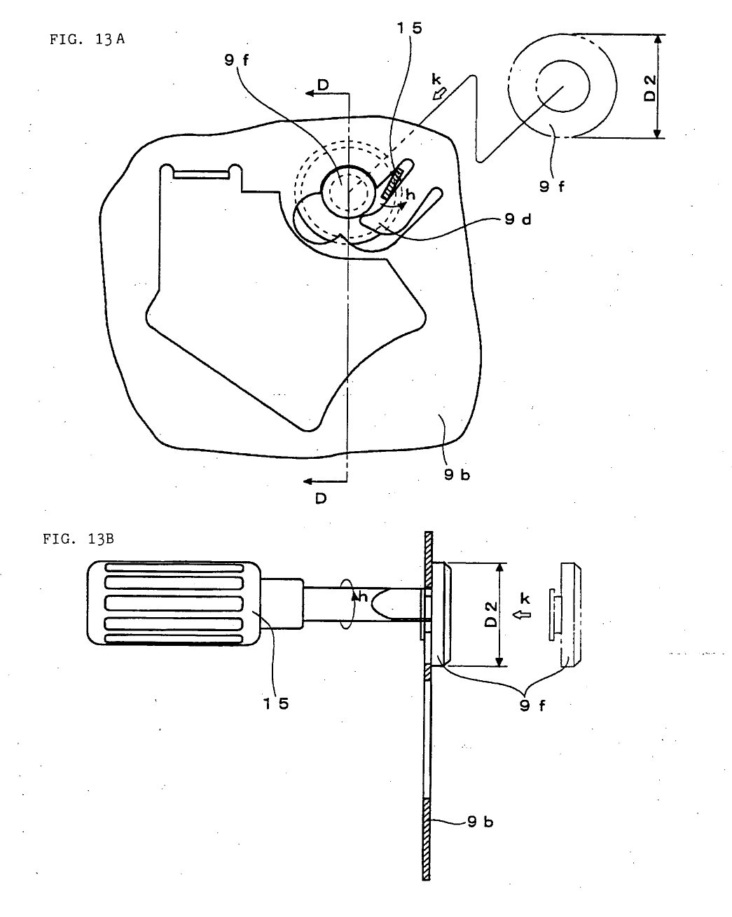

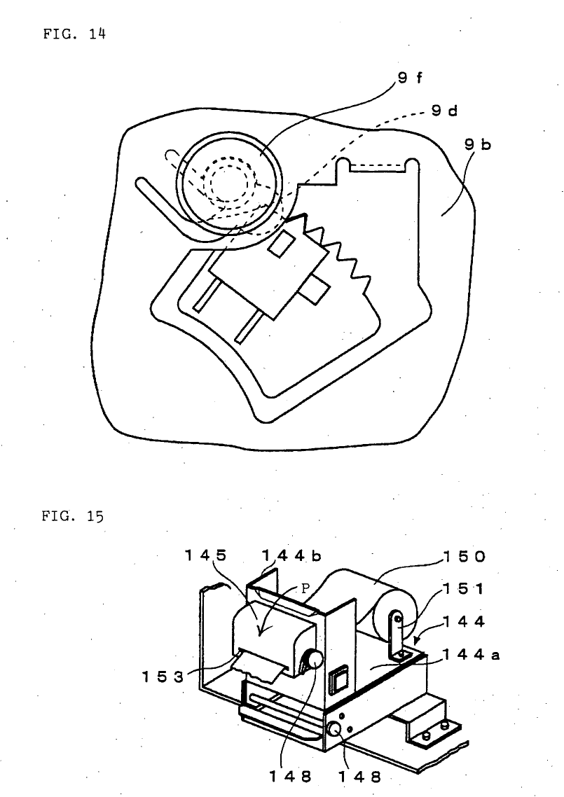

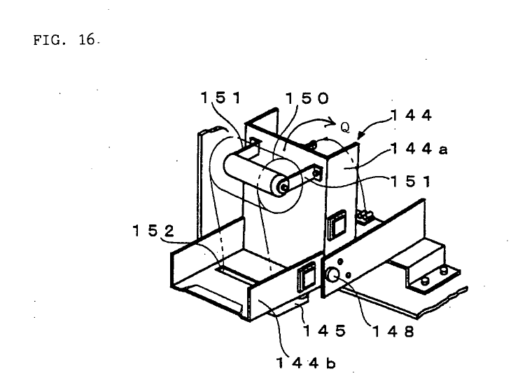

The way a second paper supporting shaft 9f is mounted on the paper holder side plate 9b will now be described with reference to FIGS. 13A and 13B.

As in the aforesaid case of the removal of the first paper supporting shaft 9e, the paper supporting shaft locking claw 9d is deformed in the direction indicated by arrow h in FIG. 13A by means of the second tool 15, and the supporting shaft 9f is attached to the paper holder side plate 9b in the direction indicated by arrow k (axial direction).

What is claimed is:

1. A printer for printing a rolled printing paper, comprising:
a frame;
a front panel swingably attached to and supported on the frame;
a print unit for printing the rolled printing paper, housed in the frame and configured to move toward the front of the frame as the front panel is opened; and
a paper holder unit for holding the rolled printing paper, housed in the frame and configured to move toward the front of the frame as the front panel is opened.

2. The printer according to claim 1, wherein the print unit is attached to a rear surface of the front panel, and the paper holder unit is mounted for longitudinal movement in the frame and coupled to the front panel by a link.

3. The printer according to claim 2, wherein a paper cutting unit for cutting the printed paper is attached to the rear surface of the front panel.

4. The printer according to claim 3, wherein the paper holder unit is formed of a bottom plate and side plates and configured to be loaded with the printing paper from above.

5. The printer according to claim 4, wherein the frame has a top opening through which the printing paper is inserted from above and loaded into the paper holder unit.

6. The printer according to claim 2, wherein the printing paper is loaded into the paper holder unit when the front panel is fully opened.

7. The printer according to claim 4, wherein the front panel is provided with a paper exit through which the printed paper is discharged, and a paper end portion of the printing paper is delivered to the paper exit through the paper cutting unit as the paper end portion is inserted into the print unit from above with the front panel open.

8. The printer according to claim 1, wherein the paper holder unit is configured to be mounted with a plurality of paper supporting shafts having different diameters.

9. The printer according to claim 6, wherein the side plates of the paper holder unit are formed individually having paper supporting shaft locking claws, and the paper supporting shafts are configured to be attached and detached by deforming the locking claws.

10. A printer for printing and discharging a rolled printing paper, comprising:
a frame having a top opening;
a front panel swingably attached to a front surface of the frame and having a paper exit through which the printed paper is discharged;
a print unit attached to the front panel and configured to print the printing paper;
a paper cutting unit attached to the front panel and configured to cut the printed paper;
a paper holder unit for holding the printing paper, mounted for longitudinal movement in the frame and coupled to the front panel by a link; and
a control circuit unit for controlling the print unit and the paper cutting unit, wherein
the control circuit unit has an adjusting element configured to be operated through the top opening of the frame when the front panel is opened halfway.

11. The printer according to claim 10, wherein the adjusting element is a DIP switch.

12. The printer according to claim 10, wherein,
a base plate is fixedly attached to the frame, a slide plate is mounted on the base plate for longitudinal movement with respect to the base plate, and further the paper holder unit is mounted on this slide plate for longitudinal movement with respect to the slide plate;
a base plate opening is formed in the base plate so as to face the adjusting element;
a slide plate opening is formed in the slide plate so that the slide plate opening faces the base plate opening of the base plate when the slide plate moves to reach a predetermined position; and
the base plate opening, slide plate opening, and paper holder bottom opening are moved to a position where these openings are aligned one another, thereby allowing the adjusting element to be operated when the front panel is opened halfway.
